(19) United States
(12) Patent Application Publication
(10) Pub. No.: US 2007/0200446 A1
(43) Pub. Date: Aug. 30, 2007

(54) Electrical machine

(76) Inventor: Sven Martin, Wolfsburg (DE)

Correspondence Address: KENYON & KENYON LLP, ONE BROADWAY, NEW YORK, NY, 10004, US

(21) Appl. No.: 11/701,675

(22) Filed: Feb. 1, 2007

(30) Foreign Application Priority Data
Feb. 1, 2006 (DE) 10 2006 004 537.8

(51) Int. Cl. H02K 23/04; H02K 21/12

(52) U.S. Cl. 310/156.43; 310/154.21; 310/156.38; 310/156.26

(57) ABSTRACT

An electrical machine includes at least one permanently excited rotor and/or stator, a magnetic field for operating the electrical machine being able to be generated, using a plurality of permanent magnets that are arranged along the circumference of the rotor and/or stator. The permanent magnets are each assembled from a plurality of individual magnet segments having the same polarization, between adjacent magnet segments at least one gap being provided, in which at least one electrically insulating layer is arranged.

### CROSS-REFERENCE TO RELATED APPLICATIONS

The present application claims priority to Application No. 10 2006 004 537.8, filed in the Federal Republic of Germany on Feb. 1, 2006, which is expressly incorporated herein in its entirety by reference thereto.

### FIELD OF THE INVENTION

The present invention relates to an electrical machine.

### BACKGROUND INFORMATION

Electrical machines work according to the dynamoelectric principle, according to which either the mechanical forces which are exerted upon a current-carrying conductor, located in the magnetic field, are used as driving forces (electric motor) or the voltage of a certain magnitude and direction, induced in a conductor by a variable magnetic field (or by transition through a magnetic field) is used to generate electrical energy (generator).

Some electrical machines, especially, for instance, brushless direct current machines, revert to permanent magnets, in this situation, to generate a constant or permanently present excitation field, which may be situated, for instance, on the rotor of the electrical machine and which then may enter into a reciprocal effect with conducting path windings located on a stator, for generating electrical energy or mechanical force.

Such a permanently excited direct current machine is described, for example, in German Published Patent Application No. 44 08 719. A generator-electric motor combination is involved in this context, which can be used as an electromagnetic torque converter or an electromagnetic transmission having a large spread, for instance, in a motor vehicle having a hybrid drive structure. The generator-electric motor combination has a housing, in this instance, in which the rotor and the stator of both the generator and the electric motor are situated, as well as a hollow cylinder generator rotor fastened to an input shaft and a hollow cylinder motor rotor fastened to an output shaft, the rotors arranged axially next to each other, and permanent magnets having changing polarity being provided at their inner side, distributed in the circumferential direction. In addition, a hollow cylinder stator, that is axially displaceable, is provided having at least one squirrel-cage winding which is connected as a function of the position of the permanent magnets of the two rotors with respect to each other. The polarity of permanent magnets, lying opposite to one another, is ascertained with the aid of magnetic field sensors between the permanent magnets, and the short circuit line is closed or opened as a function of the sensor signals. In this manner, one is able to set the rotary direction of the output shaft, while the positioning of the squirrel-cage winding under the permanent magnets of the motor rotor or the generator rotor establishes the rotary speed and the driven shaft torque of the output shaft. The switching of the squirrel-cage winding is done with the aid of controllable semiconductor elements, for example, bipolar transistors.

### SUMMARY

Example embodiments of the present invention are based, e.g., on the technical problem of creating an electrical machine which has an excitation field generated using permanent magnets, the efficiency, e.g., of the electrical machine being increased.

By a “dividing up” of the permanent magnets, e.g., a subdivision into segments that are electrically insulated from one another, the creation of eddy currents in the permanent magnets is reduced, and rotor losses and stator losses are diminished, i.e., the efficiency of the electrical machine is increased. An electrical machine includes at least one permanently excited rotor and/or stator, a magnetic field for operating the electrical machine being able to be generated using a plurality of permanent magnets that are situated along the circumference of the rotor and/or the stator, and the permanent magnets including of a plurality of individual magnet segments having the same polarization, in each case at least one gap or clearance space being provided between adjacent magnet segments in which at least one electrically insulating layer is situated. The creation of undesired eddy currents in the permanent magnets may have two different causes, in this context, which may both be present independently of each other. In electrical conductors which fully or partially enclose a magnetic flux, an electrical voltage is induced, because of the great mobility of the free charge carrier, if the conductor is moved in the magnetic field or if the magnetic flux through this conductor changes. Besides the stator and rotor, as well as the squirrel-cage windings situated on them, that are located in the excitation field, the material of the permanent magnets also has a certain current conductivity. On the one hand, the voltage induction in the stator windings or the rotor windings which lie opposite the permanent magnets, caused by the permanent excitation field, lead to the creation of a magnetic field surrounding each respective winding. This creates a so-called “armature reaction” (which, in the case of windings situated on the stator may be designated more appropriately “stator reaction”), that makes itself felt in the induction of an undesired voltage in the permanent magnets, which move in the magnetic field generated by the respective winding and surround it. This voltage leads to eddy currents closed in on themselves in the respective permanent magnets. On the other hand, the reason for the creation of undesired eddy currents in the permanent magnets may also be the rotation of the permanent magnets around the stator or rotor, for instance, because of the geometry of the stator or rotor. Since the windings of the stator or the rotor are usually arranged in slots of stators or rotors made of iron, and the gaps between the windings are then filled out by iron stator or rotor material, so-called “teeth,” the relative motion of these iron teeth leads to a constant change of iron area over the respective permanent magnet, during the rotation opposite the permanent magnet, and thus also to steady changes in the magnetic flux of the excitation field generated by the permanent magnets. Since the respective permanent magnet is also located, as an electrical conductor, in the excitation field generated by itself, the change in the magnetic flux in the excitation field also leads to a voltage in the respective permanent magnet, based on self-induction. The voltage brought about by self-induction also leads to eddy currents closed on themselves in the permanent magnet, which leads to heating of the magnetic material and thus to losses, i.e., to reduction in efficiency of the electrical machine. The eddy currents generated by both the one and the other kind generate, in the process, a magnetic field that is opposite to the “original” magnetic field, that is, the armature reaction surrounding the winding or the excitation field, according to Lenz's Rule. The voltage induced in the permanent magnet corresponds, in this instance, to U=A dB/dt, where A is the area of the permanent magnet and dB/dt is the variation with time of the magnetic flux density. The eddy current losses increase quadratically with the magnetic flux density and its frequency. In a permanently excited electrical machine, if one subdivides the surface of the permanent magnets facing the voltage-inducing magnetic field into magnet segments that are electrically insulated from one another, because of the smaller area A in the individual magnet segments, less voltage is induced and the ohmic resistance for the eddy current becomes greater. Because of this subdivision of the permanent magnet into magnetic segments, the eddy current losses may be greatly reduced.

As far as the distance apart of the permanent magnets situated in the rotor or the stator is concerned for the generation of the excitation field, for the best possible efficiency, as small a distance apart should be striven for, since by doing that, a magnetic field is able to be generated that is then stronger and has a broader action and, in the ideal case, is gapless. For example, in electrical machines that use permanent magnets having changing polarity to generate the excitation field, for instance, brushless direct current machines, however, the clearance between two permanent magnets of opposite polarity must not be too little, since a lower clearance leads to a that much more abrupt change in the polarity of the field, and thus to a that much greater change in the magnetic flux, which would bring with it so much greater eddy current losses. If, however, the eddy current losses are reduced by segmentation of the permanent magnets, even smaller clearances or wider permanent magnets having lower air gaps may be selected, so that the eddy current losses nevertheless lie only in the still acceptable range. Because of the lower clearance between the permanent magnets, in this manner the efficiency of the electrical machine may also be clearly improved.

The permanent magnets may be assembled, in the longitudinal direction, from the magnetic segments which extend transversely to the longitudinal direction of the permanent magnets. On the one hand, for the reduction in the eddy current losses that is as optimal as possible, one should strive for a dividing up of the permanent magnets into as many as possible small segments. However, if the segments are selected to be smaller, more gaps are created too, on the other hand, which have to be filled up with an electrically insulating layer, and are thus not able to contribute to the generation of the magnetic field. Consequently, one should also strive for as small as possible an overall length of the gaps between the magnetic segments, so as not unnecessarily to reduce the efficiency of the electrical machine. For example, care should be taken that the electrically insulating layer between two magnet segments is not thicker than the magnet segments themselves. It is also possible that one might have segmenting transversely to the longitudinal direction of the permanent magnets (having magnet segments extending in the longitudinal direction of the permanent magnets) in order to achieve the effect intended, but the magnet segments may extend transversely to the longitudinal direction of the permanent magnets. In this manner, one may achieve a best possible compromise of as large a number as possible of magnet segments that are as small as possible, as opposed to as short as possible an overall length of the gaps. The presence of a combined segmentation of the permanent magnets both in the longitudinal direction and in the transverse direction is possible, so that these are then composed respectively, both longitudinally and transversely, of cubic segments and parallel-shaped segments. Thereby, it is possible additionally to reduce the area of the segments, and thus further to reduce the eddy current losses. One should also take care that the segmentation of the permanent magnets extends in the axial direction of the rotor or the stator. In this manner, not only may the eddy current losses based on the self-induction of the permanent magnets be effectively reduced, but also those brought about by the armature reaction.

The permanent magnets may be aligned in the axial direction and the magnet segments in the tangential direction of the rotor and/or the stator, both the permanent magnets and the magnet segments being polarized in the radial direction of the rotor/stator. With respect to the dimensioning and alignment of the permanent magnets, on the one hand, their extension that is as great as possible in the axial direction may be provided, since, in that case, a stronger magnetic field may be generated, and thus a better performance may be achievable. Because of that, in certain applications of the electrical machine, e.g., in an electrical transmission, additional advantages may then come about, for instance, a greater possible transmission spread. Particularly in brushless direct current machines, which operate using permanent magnets of alternating polarity, additionally a lower extension of the permanent magnets in the tangential direction may be provided, since greater switching frequencies, that correspond to the polarity of the permanent magnets alternating at shorter intervals, are present, which leads to better running smoothness of the electrical machine. By increasing the number of pole pairs, the electrical machine is able to be designed as a high voltage machine having better performance characteristics. The permanent magnets may be designed to be elongated and may be aligned in the axial direction of the rotor or stator. With this in view, coupled with the recognition that dividing into magnetic segments, that are as small as possible, results in a reduction of the eddy current losses, leads one to prefer as small as possible an extension of the magnetic segments (within the scope of the restrictions with regard to the gaps to be taken into consideration, as described above) both in the axial and the tangential directions. The as small as possible arrangement of the magnetic segments for the reduction of the formation of eddy currents may be provided, e.g., in the case of brushless direct current machines having high performance characteristics, since a greater number of pole pairs provided in this case, that is permanent magnets, brings with it an increase in the required switching frequency, and the frequency increase leads to greater eddy currents in the permanent magnets, which are to be avoided in favor of a satisfying efficiency of the electrical machine, or may be reduced, for example, by the segmenting described herein. Since, however, the tangential extension of the permanent magnets—depending on the switching frequency that is to be achieved—as a rule is to selected to be constructively greater than the axial extension of the magnet segments that are as narrow as possible, the magnetic segments consequently may also be elongated, that is, wider in the tangential direction than in the axial direction. Consequently, the magnet segments may be aligned transversely to the alignment of the permanent magnets, e.g., in the tangential direction of the rotor or stator. In order to be able to maintain the generation of a directed excitation field in spite of the segmentation of the permanent magnets, one has to provide, in addition, a uniform polarization of the magnet segments within a single permanent magnet. Since the effective direction of the magnetic excitation field that is to be generated by the permanent magnets is supposed to extend radially into the center of the rotor and/or stator, and, in an alternating manner, also away from the center, a common polarization direction should accordingly be selected also for the individual magnet segments within a permanent magnet, which extends in the radial direction of the rotor and/or stator.

The electrically insulating layer may be arranged as an adhesive, which joins the magnet segments together. In this manner, the electrically insulating layer fulfills a double function, and, besides performing the insulation of the individual magnetic segments, it also contributes to their fixing as well as to the stabilization of the permanent magnet.

The electrical machine may be arranged as a generator-electric motor combination, which may be used as an electromagnetic torque converter or an electromagnetic gearing having a great spread, and includes at least one generator rotor and at least one motor rotor on whose inner side the permanent magnets are arranged along the circumference. Generator-electric motor combinations, such as the permanently excited direct current machine described in German Published Patent Application No. 44 08 719, provide a stepless and almost wear-free torque or rotary speed transmission and conversion. However, since such generator-electric motor combinations operate using a comparatively large number of pole pairs, that is, having permanent magnets arranged with alternating polarity, for their operation, these also require especially high switchover frequencies for the correct wiring configuration of the squirrel-cage windings. In this context, because of the high frequencies, eddy current losses occur in the permanent magnets to an especially great extent, which is able to be reduced by the segmentation of the permanent magnets used.

According to an example embodiment of the present invention, an electrical machine includes: at least one of a permanently excited (a) rotor and (b) stator; and a plurality of permanent magnets arranged along a circumference of the at least one of (a) the rotor and (b) the stator adapted to generate a magnetic field to operate the electrical machine being able to be generated. Each permanent magnet is formed from a plurality of individual magnet segments having a same polarization, at least one gap is provided between adjacent magnet segments, and at least one electrically insulative layer arranged in each gap.

The permanent magnets may be formed from the magnet segments in a longitudinal direction, and the magnet segments may extend transversely to the longitudinal direction.

The permanent magnets may be aligned in an axial direction, and the magnet segments may be aligned in a tangential direction of the at least one of (a) the rotor and (b) the stator. The permanent magnets and the magnet segments may be polarized in a radial direction of the at least one of (a) the rotor and (b) the stator.

The electrically insulating layer may include an adhesive material which adhesively joins the magnet segments together.

The electrical machine may be arranged as a generator-electric motor combination usable as at least one of (a) an electromagnetic torque converter and (b) an electromagnetic gearing having a great spread, the electrical machine may include at least one generator rotor and at least one motor rotor, and the permanent magnets may be arranged on an inner side of the generator motor and the motor rotor.

Further aspects and features of example embodiments of the present invention are described in further detail below with reference to the appended Figures.

### BRIEF DESCRIPTION OF THE DRAWINGS

FIG. 1 is a perspective view of a rotor of an electrical machine according to an example embodiment of the present invention.

FIG. 2 is a perspective view of a permanent magnet.

FIG. 3 is a top view of a permanent magnet.

FIG. 4 is a side view of a permanent magnet.

### DETAILED DESCRIPTION

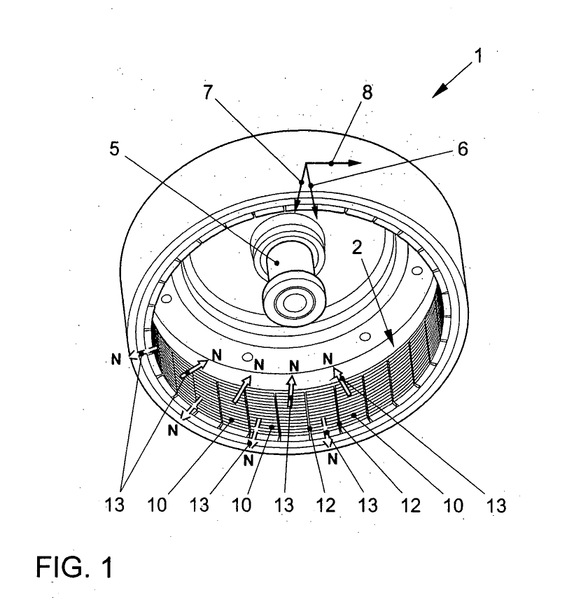

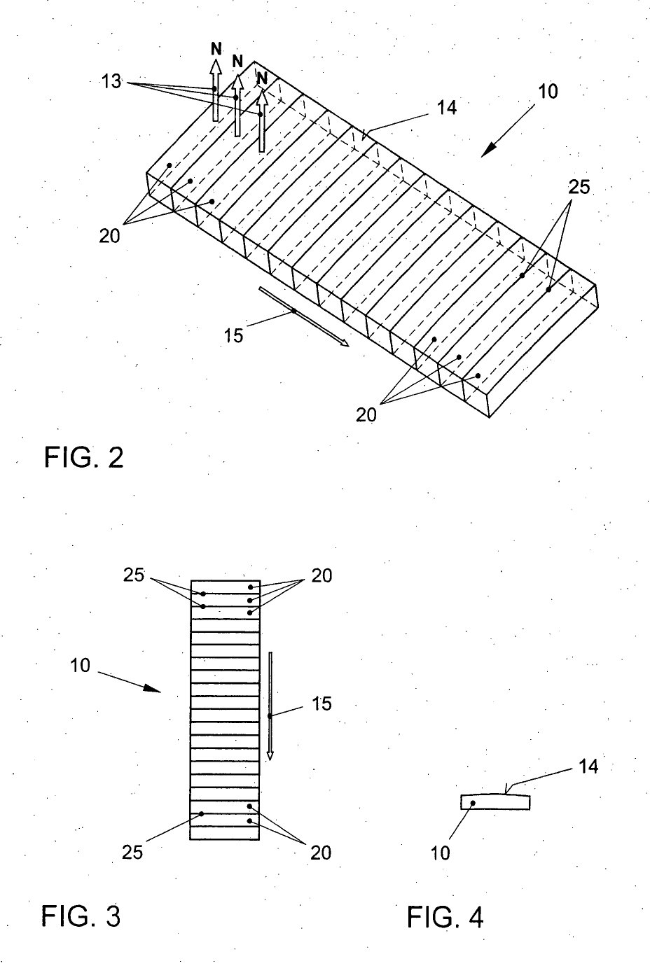

FIG. 1 schematically illustrates a rotor 1 of a generator-electric motor combination which may be used as an electromagnetic torque converter or an electromagnetic gearing. Rotor 1 is arranged as a hollow cylinder generator rotor and is fastened to a drive shaft 5. On rotor inner side 2, a plurality of permanent magnets 10 having changing polarity 13 is provided, arranged along the circumference of rotor 1. A magnetic field for driving the electrical machine is generated using permanent magnets 10 that are distributed along the circumference of rotor 1. As a further component of the electrical machine, a hollow cylinder stator that is arranged to be axially displaceable is provided, having at least one squirrel-cage winding which is switched as a function of the setting of permanent magnets 10 of rotor 1 to one another. Permanent magnets 10 are each assembled from a plurality of individual magnet segments 20 having the same polarity 13 (see, e.g., FIG. 2). Between adjacent magnet segments 20 a gap is provided in each case, in which an electrically insulating layer 25 arranged as an adhesive material is situated, by which magnet segments 20 are joined together adhesively. Between permanent magnets 10 of opposite polarity 13, situated on rotor inner side 2, in each case a gap 12 is provided. This gap should not be too small, since a particularly small gap 12 leads to a particularly abrupt change in polarity 13 of the magnetic field, and thus to a particularly strong change in the magnetic flux. However, strong magnetic flux change results in high eddy current losses. In rotor 1, since the eddy current losses may be reduced by dividing up permanent magnets 10 into magnet segments 20, comparatively small gaps 12 are provided between permanent magnets 10, so that the efficiency of rotor 1 may be increased, while the eddy current losses are nevertheless within a still acceptable range. The dividing up of permanent magnets 10 into magnet segments 20 takes place in the axial direction 6 of rotor 1, in order to reduce not only the eddy current losses based on the self-induction of permanent magnets 10, but also the eddy current losses brought about by the armature reaction. In this context, permanent magnets 10 are aligned in axial direction 6 and magnetic segments 20 are aligned in tangential direction 8 of rotor 1. Both permanent magnets 10 and magnet segments 20 are polarized in radial direction 7. Permanent magnets 10 may be elongated and aligned in the axial direction 6 of rotor 1. Magnet segments 20 may also be elongated, e.g., wider in tangential direction 8 than in axial direction 6. Consequently, magnet segments 20 may be aligned transversely to the alignment of permanent magnets 10, e.g., in the tangential direction 8 of rotor 1.

FIG. 2 is a perspective view of a permanent magnet 10 for use in a, e.g., drive side rotor 1 of an electrical machine. In this context, one may recognize that permanent magnets 10 are assembled in longitudinal direction 15 from magnet segments 20, which extend transversely to longitudinal direction 15 of permanent magnets 10. Subdivision into fourteen magnet segments may take place for the drive side use of permanent magnets 10. This subdivision corresponds to a best possible compromise of as large as possible a number of magnet segments 20 that are as small as possible, as opposed to as short as possible an overall length of the gaps provided with electrically insulating layers 25. Permanent magnet 10, for use in a rotor 1 mounted on drive shaft 5, may have a length, e.g., of 70 mm, a width, e.g., of 26.5 mm and a height of, e.g., 6 mm. The extension of a magnet segment 20 in longitudinal direction 15 of permanent magnet 10 amounts to, e.g., 5 mm in response to a subdivision into 14 magnet segments 20. Since the effective direction of the excitation field, that is to be generated by permanent magnet 10, is to extend in the radial direction 7 of rotor 1, a common polarization direction is accordingly also provided for individual magnet segments 20 within permanent magnet 10, which extend in radial direction 7 of rotor 1. Accordingly, polarities 13 of magnet segments 20 within individual permanent magnet 10 all point uniformly in the same direction, e.g., perpendicular to surface 14 of magnet segments 20.

FIG. 3 is a top view of a permanent magnet 10, for use in a, e.g., drive side rotor 1 of an electrical machine. Based on use on the driven shaft side of permanent magnet 10, different from the arrangement illustrated in FIGS. 1 and 2, an additional subdivision into twenty magnet segments 20 is provided, for example. Permanent magnet 10 then has, for example, a length of, e.g., 100 mm, a width of, e.g., 26.5 mm and a height of, e.g., 6 mm, so that the extension of a magnet segment 20 in longitudinal direction 15 of permanent magnet 10 amounts to, e.g., 5 mm, in response to a subdivision into 20 magnet segments 20.

FIG. 4 is a side view of the permanent magnet 10. In this context, it may be recognized particularly that permanent magnet 10, and thus also magnet segment 20, has a slight curvature, so as to be able to be positioned with as accurate a fit as possible on rotor inner side 2 (see, e.g., FIG. 1), aligned in axial direction 6, along the circumference of rotor 1.

### LIST OF REFERENCE NUMERALS

1 rotor
2 rotor inner side
5 drive shaft
6 axial direction
7 radial direction
8 tangential direction
10 permanent magnet
12 clearance [distance apart]
13 polarity
14 surface
15 longitudinal direction
20 magnet segment
25 electrically insulating layer

What is claimed is:

1. An electrical machine, comprising:
at least one of a permanently excited (a) rotor and (b) stator; and
a plurality of permanent magnets arranged along a circumference of the at least one of (a) the rotor and (b) the stator adapted to generate a magnetic field to operate the electrical machine being able to be generated;
wherein each permanent magnet is formed from a plurality of individual magnet segments having a same polarization, at least one gap provided between adjacent magnet segments, at least one electrically insulative layer arranged in each gap.

2. The electrical machine according to claim 1, wherein the permanent magnets are formed from the magnet segments in a longitudinal direction, the magnet segments extending transversely to the longitudinal direction.

3. The electrical machine according to claim 1, wherein the permanent magnets are aligned in an axial direction and the magnet segments are aligned in a tangential direction of the at least one of (a) the rotor and (b) the stator, the permanent magnets and the magnet segments polarized in a radial direction of the at least one of (a) the rotor and (b) the stator.

4. The electrical machine according to claim 1, wherein the electrically insulating layer includes an adhesive material which adhesively joins the magnet segments together.

5. The electrical machine according to claim 1, wherein the electrical machine is arranged as a generator-electric motor combination usable as at least one of (a) an electromagnetic torque converter and (b) an electromagnetic gearing having a great spread, the electrical machine including at least one generator rotor and at least one motor rotor, the permanent magnets arranged on an inner side of the generator motor and the motor rotor.
